(19) United States
(12) Patent Application Publication
(10) Pub. No.: US 2017/0116884 A1
(43) Pub. Date: Apr. 27, 2017

(54) METHOD FOR PROVIDING INFORMATION AND ELECTRONIC DEVICE SUPPORTING THE SAME

(71) Applicant: SAMSUNG ELECTRONICS CO., LTD., Suwon-si (KR)

(72) Inventor: Jihyun CHOI, Seoul (KR)

(21) Appl. No.: 15/297,749

(22) Filed: Oct. 19, 2016

(30) Foreign Application Priority Data
Oct. 22, 2015 (KR) 10-2015-0147107

(51) Int. Cl. G09B 21/00; G06F 3/041; G06F 3/0488; G06F 3/01

(52) U.S. Cl. CPC G09B 21/004; G06F 3/016; G06F 3/0416; G06F 3/04886

(57) ABSTRACT

A method for providing information and an electronic device supporting the same are provided. The electronic device includes a communication interface including communication circuitry configured to receive information from an external device, and a processor. The processor is configured to output a haptic effect for at least one Braille key among a plurality of Braille keys, based on the information received through the communication interface.

### CROSS REFERENCE TO RELATED APPLICATION

This application is based on and claims priority under 35 U.S.C. §119 to a Korean Patent Application filed in the Korean Intellectual Property Office on Oct. 22, 2015 and assigned Serial No. 10-2015-0147107, the contents of which are incorporated by reference herein in its entirety.

### BACKGROUND

1. Field

The disclosure relates generally to a method for providing information and an electronic device supporting the same.

2. Description of Related Art

With the recent growth of digital technologies, various types of electronic devices are being widely used such as mobile communication terminals, smart phones, tablet Personal Computers (PCs), Personal Digital Assistants (PDAs), electronic organizers, notebook computers, wearable devices, Televisions (TVs), etc. The use of these electronic devices is becoming popular for the disabled, for example, even visually impaired persons.

An existing electronic device for the disabled is providing information in a form of outputting a voice using a technology (e.g., Text To Speed (TTS)) of converting received information into a voice when the information is received from the external.

However, in case where a user who makes use of the electronic device for the disabled receives information in a public place, it may occur that the user fails to recognize a notification of information reception or fails to identify the information outputted in a voice form, owing to surrounding noises. Also, in case where the information is outputted in the voice form, there is a problem of failing to protect user's personal information.

Also, in case where the notification setting of the electronic device is set to a vibration mode or a mute mode, the user may fail to identify the information outputted in the voice form even if recognizing an information notification.

### SUMMARY

Various example embodiments of the disclosure allow a user to recognize received information, by supporting output of a haptic effect for a Braille key to represent Braille corresponding to data included in the received information.

Technological solutions addressed by the present disclosure are not limited to the above-mentioned technological solutions, and other technological solutions not mentioned above will be able to be clearly understood by those skilled in the art from the following description.

An electronic device according to various example embodiments can include a communication interface including communication circuitry configured to receive information from an external device, and a processor configured to allow output of a haptic effect for at least one Braille key among a plurality of Braille keys, based on the information received through the communication interface.

A method for providing information of an electronic device according to various example embodiments can include receiving information through a communication interface, and outputting a haptic effect for at least one Braille key among a plurality of Braille keys, based on the received information.

### BRIEF DESCRIPTION OF THE DRAWINGS

The foregoing and other aspects of the disclosure will become more apparent and readily understood from the following detailed description, taken in conjunction with the accompanying drawings, in which like reference numerals refer to like elements, and wherein:

FIG. 1 is a diagram illustrating an example environment of a network including an electronic device according to various example embodiments.

FIG. 2 is a block diagram illustrating an example electronic device according to various example embodiments.

FIG. 3 is a block diagram illustrating an example program module according to various example embodiments.

FIG. 4 is a conceptual diagram illustrating an example method for providing information according to an example embodiment.

FIGS. 5A and 5B are diagrams illustrating an example principle of outputting a plurality of Braille keys according to an example embodiment.

FIG. 6 is a flowchart illustrating an example method for providing information according to an example embodiment.

FIGS. 7A and 7B are diagrams illustrating an example method for providing information according to an example embodiment.

FIG. 8 is a flowchart illustrating an example method of outputting a haptic effect for at least one Braille key among a plurality of Braille keys according to an example embodiment.

FIG. 9 is a diagram illustrating an example method of outputting a haptic effect for at least one Braille key among a plurality of Braille keys according to an example embodiment.

FIG. 10 is a diagram illustrating an example method of outputting a haptic effect for at least one Braille key among a plurality of Braille keys according to another example embodiment.

FIG. 11 is a diagram illustrating an example method of outputting a haptic effect for at least one Braille key among a plurality of Braille keys according to a further example embodiment.

FIG. 12 is a flowchart illustrating an example method of outputting a haptic effect for at least one Braille key among a plurality of Braille keys according to another example embodiment.

FIG. 13 is a flowchart illustrating an example method of outputting a haptic effect for at least one Braille key among a plurality of Braille keys according to a further example embodiment.

FIGS. 14, 15A, 15B, 15C and 15D are diagrams illustrating an example method of outputting a haptic effect for at least one Braille key among a plurality of Braille keys according to a yet another example embodiment.

### DETAILED DESCRIPTION

Hereinafter, various example embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including both at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may refer, for example to the device, together with other devices or components, “is able to”. For example, the phrase “processor adapted (or configured) to perform A, B, and C” may refer, for example, to a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing particular embodiments and are not intended to limit the scope of other embodiments. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

An electronic device according to various embodiments of the present disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device, or the like. According to various embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit), or the like.

According to some embodiments, the electronic device may be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and PlayStation™), an electronic dictionary, an electronic key, a camcorder, and an electronic photo frame, or the like.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.), or the like.

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter), or the like. The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology.

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

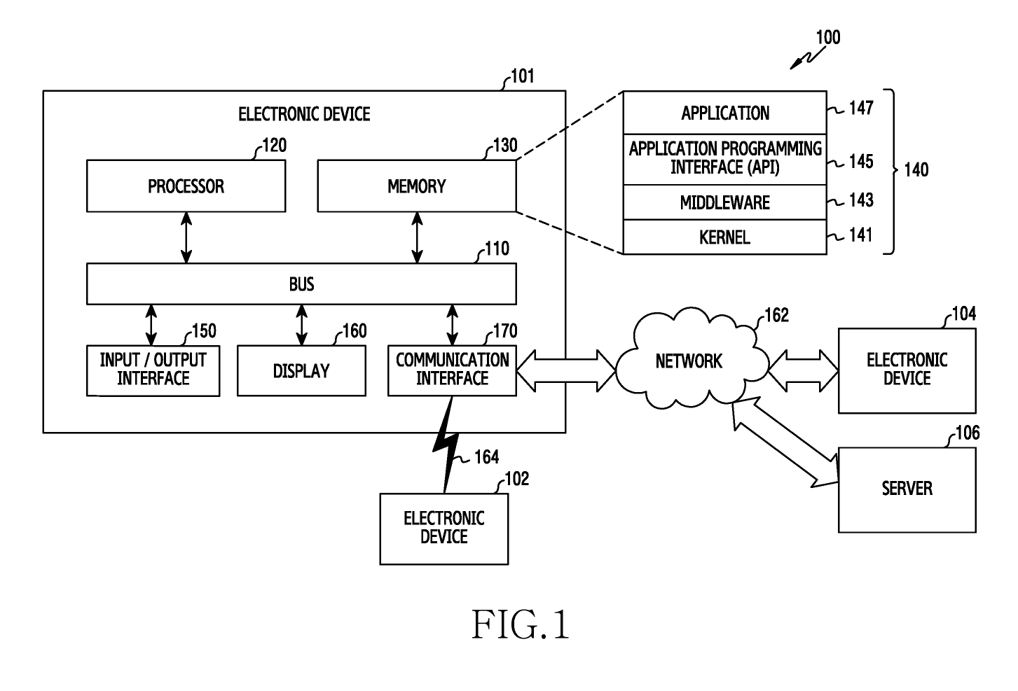

FIG. 1 is a diagram illustrating an example network environment including an electronic device according to various embodiments of the present disclosure.

An electronic device 101 within a network environment 100, according to various embodiments, will be described with reference to FIG. 1. The electronic device 101 may include a bus 110, a processor 120, a memory 130, an input/output interface 150, a display 160, and a communication interface 170. In some embodiments, the electronic device 101 may omit at least one of the above elements or may further include other elements.

The bus 110 may include, for example, a circuit for connecting the elements 110-170 and transferring communication (e.g., control messages and/or data) between the elements.

The processor 120 may include one or more of a Central Processing Unit (CPU), an Application Processor (AP), and a Communication Processor (CP). The processor 120, for example, may carry out operations or data processing relating to control and/or communication of at least one other element of the electronic device 101.

The memory 130 may include a volatile memory and/or a non-volatile memory. The memory 130 may store, for example, instructions or data relevant to at least one other element of the electronic device 101. According to an embodiment, the memory 130 may store software and/or a program 140. The program 140 may include, for example, a kernel 141, middleware 143, an Application Programming Interface (API) 145, and/or application programs (or “applications”) 147. At least some of the kernel 141, the middleware 143, and the API 145 may be referred to as an Operating System (OS).

The kernel 141 may control or manage system resources (e.g., the bus 110, the processor 120, or the memory 130) used for performing an operation or function implemented by the other programs (e.g., the middleware 143, the API 145, or the application programs 147). Furthermore, the kernel 141 may provide an interface through which the middleware 143, the API 145, or the application programs 147 may access the individual elements of the electronic device 101 to control or manage the system resources.

The middleware 143, for example, may function as an intermediary for allowing the API 145 or the application programs 147 to communicate with the kernel 141 to exchange data.

In addition, the middleware 143 may process one or more operation requests received from the application program 147 according to priority. For example, the middleware 143 may give priority to use the system resources of the electronic device 101 (for example, the bus 110, the processor 120, the memory 130, and the like) to at least one of the application programs 147. For example, the middleware 143 may perform scheduling or load balancing with respect to the one or more operation requests by processing the one or more operation requests according to the priority given to the at least one application program.

The API 145 is an interface through which the applications 147 control functions provided from the kernel 141 or the middleware 143, and may include, for example, at least one interface or function (e.g., instruction) for file control, window control, image processing, or text control.

The input/output interface 150, for example, may include various input/output circuitry configured to function as an interface that may transfer instructions or data input from a user or another external device to the other element(s) of the electronic device 101. Furthermore, the input/output interface 150 may output the instructions or data received from the other element(s) of the electronic device 101 to the user or another external device.

The display 160 may include, for example, a Liquid Crystal Display (LCD), a Light Emitting Diode (LED) display, an Organic Light Emitting Diode (OLED) display, a Micro Electro Mechanical System (MEMS) display, or an electronic 30 paper display. The display 160, for example, may display various types of content (e.g., text, images, videos, icons, or symbols) for the user. The display 160 may include a touch screen and receive, for example, a touch, gesture, proximity, or hovering input using an electronic pen or the user's body part.

The communication interface 170, for example, may include various communication circuitry configured to set communication between the electronic device 101 and an external device (e.g., the first external electronic device 102, the second external electronic device 104, or a server 106). For example, the communication interface 170 may be connected to a network 162 through wireless or wired communication to communicate with the external device (e.g., the second external electronic device 104 or the server 106).

The wireless communication may use at least one of, for example, Long Term Evolution (LTE), LTE-Advance (LTE-A), Code Division Multiple Access (CDMA), Wideband CDMA (WCDMA), Universal Mobile Telecommunications System (UMTS), WiBro (Wireless Broadband), and Global System for Mobile Communications (GSM), as a cellular communication protocol. In addition, the wireless communication may include, for example, short range communication 164. The short-range communication 164 may be performed by using at least one of, for example, Wi-Fi, Bluetooth, Bluetooth low energy (BLE), Near Field Communication (NFC), and Global Navigation Satellite System (GNSS). The GNSS may include at least one of, for example, a Global Positioning System (GPS), a Global Navigation Satellite System (Glonass), a Beidou Navigation Satellite System (hereinafter referred to as “Beidou”), and a European Global Satellite-based Navigation System (Galileo), according to a use area, a bandwidth, or the like. Hereinafter, in the present disclosure, the “GPS” may be interchangeably used with the “GNSS”. The wired communication may include at least one of, for example, a Universal Serial Bus (USB), a High Definition Multimedia Interface (HDMI), Recommended Standard 232 (RS-232), and a Plain Old Telephone Service (POTS). The network 162 may include at least one of a communication network such as a computer network (e.g., a LAN or a WAN), the Internet, and a telephone network.

Each of the first and second external electronic apparatuses 102 and 104 may be of a type identical to or different from that of the electronic apparatus 101. According to an embodiment, the server 106 may include a group of one or more servers. According to various embodiments, all or some of the operations performed in the electronic device 101 may be performed in another electronic device or a plurality of electronic devices (e.g., the electronic devices 102 and 104 or the server 106). According to an embodiment, when the electronic device 101 has to perform some functions or services automatically or in response to a request, the electronic device 101 may make a request for performing at least some functions relating thereto to another device (e.g., the electronic device 102 or 104 or the server 106) instead of performing the functions or services by itself or in addition. Another electronic apparatus may execute the requested functions or the additional functions, and may deliver a result of the execution to the electronic apparatus 101. The electronic device 101 may process the received result as it is or additionally to provide the requested functions or services. To achieve this, for example, cloud computing, distributed computing, or client-server computing technology may be used.

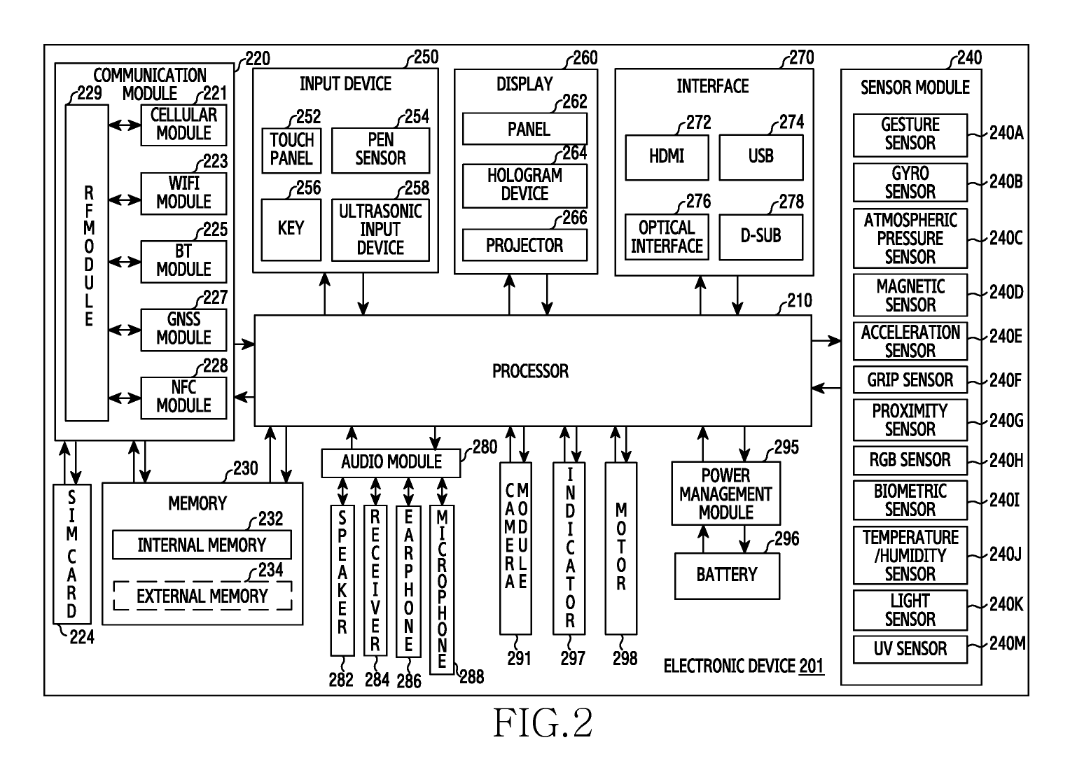

FIG. 2 is a block diagram illustrating an example electronic device according to various example embodiments of the present disclosure.

FIG. 2 is a block diagram of an electronic device 201 according to various embodiments. For example, the electronic apparatus 201 may include the whole or part of the electronic apparatus 101 illustrated in FIG. 1. The electronic device 201 may include at least one processor (e.g., Application Processor (AP)) 210, a communication module (e.g., including communication circuitry) 220, a Subscriber Identification Module (SIM) 224, a memory 230, a sensor module 240, an input device (e.g., including input circuitry) 250, a display 260, an interface 270, an audio module 280, a camera module 291, a power management module 295, a battery 296, an indicator 297, and a motor 298.

The processor 210 may control a plurality of hardware or software components connected to the processor 210 by driving an operating system or an application program and perform processing of various pieces of data and calculations. The processor 210 may be implemented by, for example, a System on Chip (SoC). According to an embodiment, the processor 210 may further include a Graphic Processing Unit (GPU) and/or an image signal processor. The processor 210 may include at least some (e.g., a cellular module 221) of the elements illustrated in FIG. 2. The processor 210 may load, into a volatile memory, instructions or data received from at least one (e.g., a non-volatile memory) of the other elements and may process the loaded instructions or data, and may store various data in a non-volatile memory.

The communication module 220 may include, for example, various communication circuitry having a configuration equal or similar to that of the communication interface 170 of FIG. 1. The communication module 220 may include various communication circuitry, such as, for example, and without limitation the cellular module 221, a Wi-Fi module 223, a Bluetooth (BT) module 225, a Bluetooth low energy module 226, a GNSS module 227 (e.g., a GPS module, a Glonass module, a Beidou module, or a Galileo module), an NFC module 228, and a Radio Frequency (RF) module 229.

The cellular module 221 may provide a voice call, image call, a text message service, or an Internet service through, for example, a communication network. According to an embodiment, the cellular module 221 may distinguish between and authenticate electronic devices 201 within a communication network using a subscriber identification module (for example, the SIM card 224). According to an embodiment of the present disclosure, the cellular module 221 may perform at least some of the functions that the processor 210 may provide. According to an embodiment, the cellular module 221 may include a Communication Processor (CP).

Each of the Wi-Fi module 223, the BT module 225, the Bluetooth low energy module 226, the GNSS module 227, and the NFC module 228 may include, for example, a processor for processing data transmitted and received through the relevant module. According to some embodiments of the present disclosure, at least some (e.g., two or more) of the cellular module 221, the Wi-Fi module 223, the BT module 225, the GNSS module 227, and the NFC module 228 may be included in one Integrated Chip (IC) or IC package.

The RF module 229 may transmit/receive, for example, a communication signal (for example, an RF signal). The RF module 229 may include, for example, a transceiver, a Power Amplifier Module (PAM), a frequency filter, a Low Noise Amplifier (LNA), and an antenna. According to another embodiment of the present disclosure, at least one of the cellular module 221, the Wi-Fi module 223, the BT module 225, the Bluetooth low energy module 226, the GNSS module 227, and the NFC module 228 may transmit and receive RF signals through a separate RF module.

The subscriber identification module 224 may include, for example, a card including a subscriber identity module and/or an embedded SIM, and may contain unique identification information (e.g., an Integrated Circuit Card Identifier (ICCID)) or subscriber information (e.g., an International Mobile Subscriber Identity (IMSI)).

The memory 230 (for example, the memory 130) may include, for example, an internal memory 232 or an external memory 234. The embedded memory 232 may include at least one of a volatile memory (for example, a Dynamic Random Access Memory (DRAM), a Static RAM (SRAM), a Synchronous Dynamic RAM (SDRAM), and the like) and a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (for example, a NAND flash memory or a NOR flash memory), a hard disc drive, a Solid State Drive (SSD), and the like).

The external memory 234 may further include a flash drive, for example, a Compact Flash (CF), a Secure Digital (SD), a Micro Secure Digital (Micro-SD), a Mini Secure Digital (Mini-SD), an eXtreme Digital (xD), a memory stick, or the like. The external memory 234 may be functionally and/or physically connected to the electronic apparatus 201 through various interfaces.

The sensor module 240 may measure a physical quantity or detect an operation state of the electronic device 201, and may convert the measured or detected information into an electrical signal. For example, the sensor module 240 may include at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (for example, a Red/Green/Blue (RGB) sensor), a biometric sensor 2401, a temperature/humidity sensor 240J, a light sensor 240K, and an Ultra Violet (UV) sensor 240M. Additionally or alternatively, the sensor module 240 may include, for example, an E-nose sensor, an electromyography (EMG) sensor, an electroencephalogram (EEG) sensor, an electrocardiogram (ECG) sensor, an Infrared (IR) sensor, an iris sensor, and/or a fingerprint sensor. The sensor module 240 may further include a control circuit for controlling one or more sensors included therein. In some embodiments of the present disclosure, the electronic apparatus 201 may further include a processor configured to control the sensor module 240 as a part of or separately from the processor 210, and may control the sensor module 240 while the processor 210 is in a sleep state.

The input device 250 may include various input circuitry, for example, a touch panel 252, a (digital) pen sensor 254, a key 256, or an ultrasonic input device 258. The touch panel 252 may use at least one of, for example, a capacitive type, a resistive type, an infrared type, and an ultrasonic type. Also, the touch panel 252 may further include a control circuit. The touch panel 252 may further include a tactile layer and provide a tactile reaction to the user.

The (digital) pen sensor 254 may include, for example, a recognition sheet which is a part of the touch panel or is separated from the touch panel. The key 256 may include, for example, a physical button, an optical key or a keypad. The ultrasonic input device 258 may detect ultrasonic wavers generated by an input tool through a microphone (for example, a microphone 288) and identify data corresponding to the detected ultrasonic waves.

The display 260 (for example, the display 160) may include a panel 262, a hologram device 264 or a projector 266. The panel 262 may include a configuration that is identical or similar to the display 160 illustrated in FIG. 1. The panel 262 may be implemented to be, for example, flexible, transparent, or wearable. The panel 262 and the touch panel 252 may be implemented as one module. The hologram 264 may show a three dimensional image in the air by using an interference of light. The projector 266 may display an image by projecting light onto a screen. The screen may be located, for example, inside or outside the electronic apparatus 201. According to an embodiment, the display 260 may further include a control circuit for controlling the panel 262, the hologram device 264, or the projector 266.

The interface 270 may include various interface circuitry, for example, a High-Definition Multimedia Interface (HDMI) 272, a Universal Serial Bus (USB) 274, an optical interface 276, or a D-subminiature (D-sub) 278. The interface 270 may be included in, for example, the communication interface 170 illustrated in FIG. 1. Additionally or alternatively, the interface 270 may include, for example, a Mobile High-definition Link (MHL) interface, a Secure Digital (SD) card/Multi-Media Card (MMC) interface, or an Infrared Data Association (IrDA) standard interface.

The audio module 280 may bilaterally convert, for example, a sound and an electrical signal. At least some elements of the audio module 280 may be included in, for example, the input/output interface 145 illustrated in FIG. 1. The audio module 280 may process sound information which is input or output through, for example, a speaker 282, a receiver 284, earphones 286, the microphone 288 or the like.

The camera module 291 is a device which may photograph a still image and a dynamic image. According to an embodiment, the camera module 291 may include one or more image sensors (for example, a front sensor or a back sensor), a lens, an Image Signal Processor (ISP) or a flash (for example, LED or xenon lamp).

The power management module 295 may manage, for example, power of the electronic device 201. According to an embodiment, the power management module 295 may include a Power Management Integrated Circuit (PMIC), a charger Integrated Circuit (IC), or a battery or fuel gauge. The PMIC may use a wired and/or wireless charging method. Examples of the wireless charging method may include, for example, a magnetic resonance method, a magnetic induction method, an electromagnetic method, and the like. Additional circuits (e.g., a coil loop, a resonance circuit, a rectifier, etc.) for wireless charging may be further included. The battery gauge may measure, for example, a residual quantity of the battery 296, and a voltage, a current, or a temperature during the charging. The battery 296 may include, for example, a rechargeable battery or a solar battery.

The indicator 297 may display a particular state (e.g., a booting state, a message state, a charging state, or the like) of the electronic apparatus 201 or a part (e.g., the processor 210). The motor 298 may convert an electrical signal into mechanical vibration, and may generate vibration, a haptic effect, or the like. Although not illustrated, the electronic apparatus 201 may include a processing unit (e.g., a GPU) for supporting a mobile television (TV). The processing unit for supporting mobile TV may, for example, process media data according to a certain standard such as Digital Multimedia Broadcasting (DMB), Digital Video Broadcasting (DVB), or mediaFLO™.

Each of the above-described component elements of hardware according to the present disclosure may be configured with one or more components, and the names of the corresponding component elements may vary based on the type of electronic device. The electronic device according to various embodiments of the present disclosure may include at least one of the aforementioned elements. Some elements may be omitted or other additional elements may be further included in the electronic device. Also, some of the hardware components according to various embodiments may be combined into one entity, which may perform functions identical to those of the relevant components before the combination.

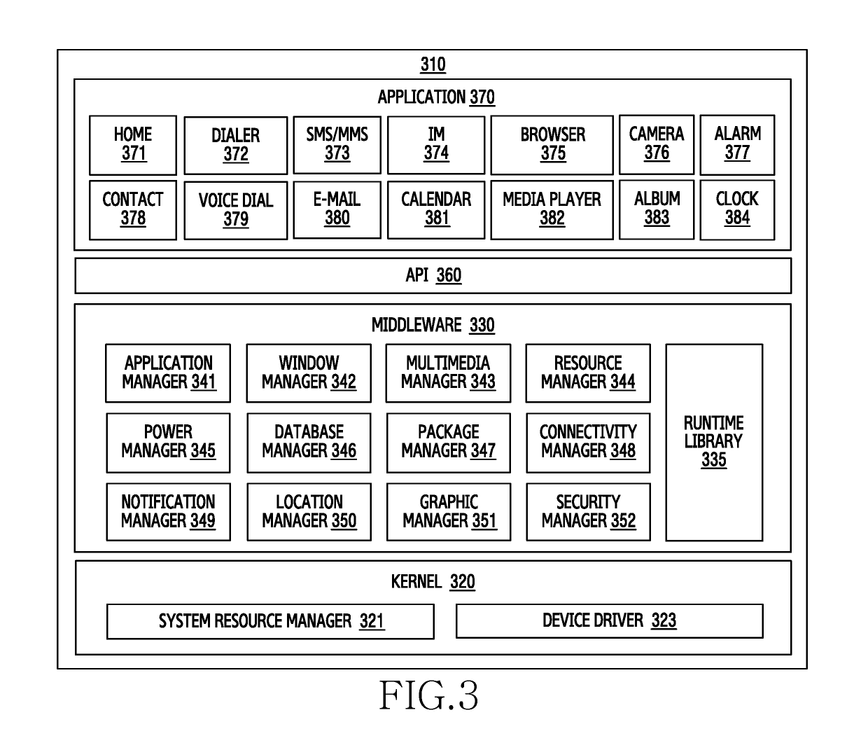

FIG. 3 is a block diagram illustrating an example program module according to various example embodiments of the present disclosure.

According to an embodiment, the program module 310 (for example, the program 140) may include an Operating System (OS) for controlling resources related to the electronic device (for example, the electronic device 101) and/or various applications (for example, the application programs 147) executed in the operating system. The operating system may be, for example, Android, iOS, Windows, Symbian, Tizen, Bada, or the like.

The program module 310 may include a kernel 320, middleware 330, an API 360, and/or an application 370. At least some of the program module 310 may be preloaded on the electronic apparatus, or may be downloaded from an external electronic apparatus (e.g., the electronic apparatus 102 or 104, or the server 106).

The kernel 320 (e.g., the kernel 141) may include, for example, a system resource manager 321 and/or a device driver 323. The system resource manager 321 may perform the control, allocation, retrieval, or the like of system resources. According to an embodiment of the present disclosure, the system resource manager 321 may include a process manager, a memory manager, a file system manager, or the like. The device driver 323 may include, for example, a display driver, a camera driver, a Bluetooth driver, a shared memory driver, a USB driver, a keypad driver, a Wi-Fi driver, an audio driver, or an Inter-Process Communication (IPC) driver.

The middleware 330 may provide a function required by the applications 370 in common or provide various functions to the applications 370 through the API 360 so that the applications 370 can efficiently use limited system resources within the electronic device. According to an embodiment, the middleware 330 (for example, the middleware 143) may include, for example, at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses in order to add a new function through a programming language while the applications 370 are being executed. The runtime library 335 may perform input/output management, memory management, the functionality for an arithmetic function, or the like.

The application manager 341 may manage, for example, the life cycle of at least one of the applications 370. The window manager 342 may manage Graphical User Interface (GUI) resources used for the screen. The multimedia manager 343 may determine a format required to reproduce various media files, and may encode or decode a media file by using a coder/decoder (codec) appropriate for the relevant format. The resource manager 344 may manage resources, such as a source code, a memory, a storage space, and the like of at least one of the applications 370.

The power manager 345 may operate together with a Basic Input/Output System (BIOS) to manage a battery or power and may provide power information required for the operation of the electronic device. The database manager 346 may generate, search for, and/or change a database to be used by at least one of the applications 370. The package manager 347 may manage the installation or update of an application distributed in the form of a package file.

The connectivity manager 348 may manage a wireless connection such as, for example, Wi-Fi or Bluetooth. The notification manager 349 may display or notify of an event, such as an arrival message, an appointment, a proximity notification, and the like, in such a manner as not to disturb the user. The location manager 350 may manage location information of the electronic apparatus. The graphic manager 351 may manage a graphic effect, which is to be provided to the user, or a user interface related to the graphic effect. The security manager 352 may provide various security functions required for system security, user authentication, and the like. According to an embodiment of the present disclosure, when the electronic apparatus (e.g., the electronic apparatus 101) has a telephone call function, the middleware 330 may further include a telephony manager for managing a voice call function or a video call function of the electronic apparatus.

The middleware 330 may include a middleware module that forms a combination of various functions of the above-described elements. The middleware 330 may provide a module specialized for each type of OS in order to provide a differentiated function. Also, the middleware 330 may dynamically delete some of the existing elements, or may add new elements.

The API 360 (e.g., the API 145) is, for example, a set of API programming functions, and may be provided with a different configuration according to an OS. For example, in the case of Android or iOS, one API set may be provided for each platform. In the case of Tizen, two or more API sets may be provided for each platform.

The applications 370 (for example, the application program 147) may include, for example, one or more applications which can provide functions such as home 371, dialer 372, SMS/MMS 373, Instant Message (IM) 374, browser 375, camera 376, alarm 377, contact 378, voice dial 379, e-mail 380, calendar 381, media player 382, album 383, clock 384, health care (for example, measure exercise quantity or blood sugar), or environment information (for example, atmospheric pressure, humidity, or temperature information).

According to an embodiment of the present disclosure, the applications 370 may include an application (hereinafter, referred to as an “information exchange application” for convenience of description) supporting information exchange between the electronic apparatus (e.g., the electronic apparatus 101) and an external electronic apparatus (e.g., the electronic apparatus 102 or 104). The application associated with information exchange may include, for example, a notification relay application for forwarding specific information to an external electronic device, or a device management application for managing an external electronic device.

For example, the notification relay application may include a function of delivering, to the external electronic apparatus (e.g., the electronic apparatus 102 or 104), notification information generated by other applications (e.g., an SMS/MMS application, an email application, a health care application, an environmental information application, etc.) of the electronic apparatus 101. Further, the notification relay application may receive notification information from, for example, an external electronic device and provide the received notification information to a user.

The device management application may manage (for example, install, delete, or update), for example, a function for at least a part of the external electronic device (for example, the electronic device 102 or 104) communicating with the electronic device (for example, turning on/off the external electronic device itself (or some elements thereof) or adjusting brightness (or resolution) of a display), applications executed in the external electronic device, or services provided from the external electronic device (for example, a telephone call service or a message service).

According to an embodiment, the applications 370 may include applications (for example, a health care application of a mobile medical appliance or the like) designated according to attributes of the external electronic device 102 or 104. According to an embodiment of the present disclosure, the application 370 may include an application received from the external electronic apparatus (e.g., the server 106, or the electronic apparatus 102 or 104). According to an embodiment of the present disclosure, the application 370 may include a preloaded application or a third party application which can be downloaded from the server. Names of the elements of the program module 310, according to the above-described embodiments of the present disclosure, may change depending on the type of OS.

According to various embodiments of the present disclosure, at least some of the program module 310 may be implemented in software, firmware, hardware, or a combination of two or more thereof. At least some of the program module 310 may be implemented (e.g., executed) by, for example, the processor (e.g., the processor 210). At least some of the program module 310 may include, for example, a module, a program, a routine, a set of instructions, and/or a process for performing one or more functions.

The term “module” as used herein may refer, for example, to a unit including one of hardware (e.g., processing circuitry), software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

The module or the program module, according to various embodiments, may: include one or more elements described above; exclude some of them; or further include other elements. The operations performed by the module, the program module, or other elements, according to various embodiments, may be executed in a sequential, parallel, iterative, or heuristic method. In addition, some operations may be executed in a different order, or may be omitted, or other operations may be added. In addition, the embodiments disclosed in the present document are intended for the explanation and understanding of the technical matter, and shall not limit the scope of the technology described in the present document. Accordingly, the scope of the present disclosure should be construed to encompass all modifications or various other embodiments based on the technical concept of the present disclosure.

In addition, the embodiments disclosed in the present document are intended for the explanation and understanding of the disclosed technical matter, and shall not limit the scope of various embodiments of the present document. Therefore, the scope of various embodiments of the present document should be construed to encompass all modifications or various other embodiments based on the technical concept of the various embodiments of the present disclosure.

An electronic device according to various example embodiments can include a communication interface for receiving information from an external device, and a processor. The processor can allow to output a haptic effect for at least one Braille key among a plurality of Braille keys, based on the information received through the communication interface.

In one example embodiment, the plurality of Braille keys can be implemented using Electro-Mechanical Polymers (EMPs).

In one example embodiment, the haptic effect for the at least one Braille key can include a vibration or tactile response of the at least one Braille key.

In one exemplary embodiment, the processor can allow to determine data to output the haptic effect based at least on the received information and, if receiving a touch input for a Braille key mapped to the determined data, output a haptic effect for the Braille key mapped to the determined data.

In one example embodiment, while receiving the touch input for the Braille key mapped to the determined data, the processor can output the haptic effect, and determine data corresponding to the next order of the determined data, as the data to output the haptic effect.

In one example embodiment, the processor can determine data to output the haptic effect based at least on the received information, and output a haptic effect for a Braille key mapped to the determined data.

In one example embodiment, if receiving a touch input for the mapped Braille key, the processor can determine data corresponding to the next order of the determined data, as the data to output the haptic effect.

In one example embodiment, if receiving a touch input from a user, the processor can allow to sequentially output each of data included in the received information using the haptic effect.

In one example embodiment, if receiving the information through the communication interface, the processor can allow to output a notification notifying the information reception.

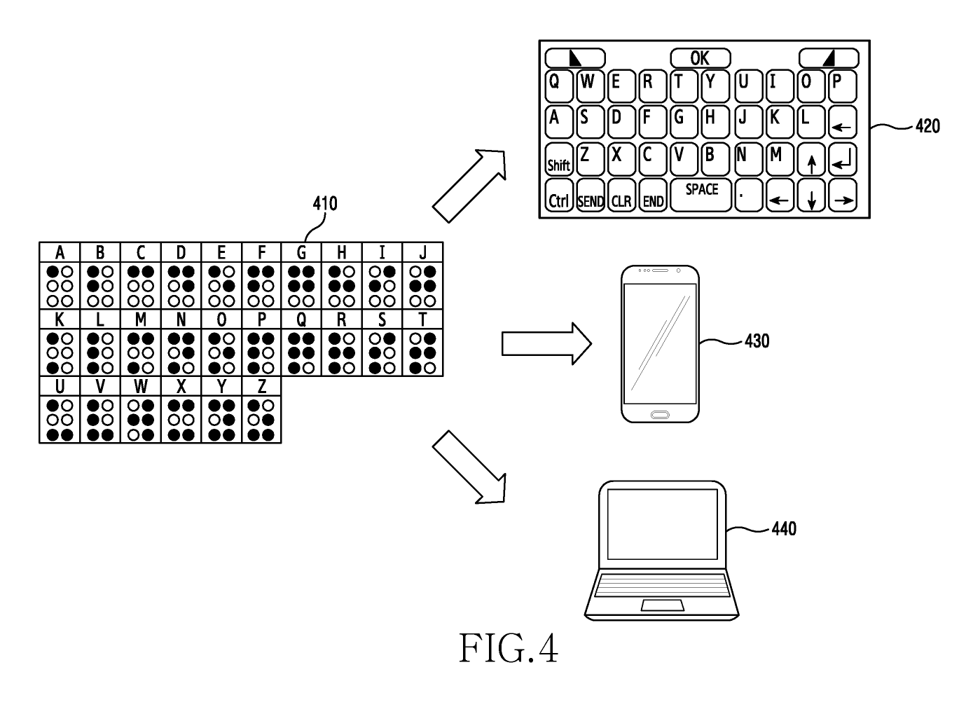

FIG. 4 is a conceptual diagram illustrating an example method for providing information according to one example embodiment.

FIG. 4 illustrates an example of a Braille chart 410 (or Braille table) including a plurality of Braille and the electronic device 101 capable of inputting or outputting the plurality of Braille.

In one example embodiment, Braille exemplifies English language (or alphabet) Braille, but is not limited to this. For example, Braille can include Braille corresponding to a Korean language (or Korean) (e.g., an initial consonant, a vowel, a final consonant, an abbreviated syllable, and an abbreviated word), a numeral, and a punctuation mark, as well as an English language.

In one example embodiment, if receiving information from an external device, the electronic device 101 can output the received information in a haptic form using at least one Braille key. For example, in case where the electronic device 101 includes a plurality of Braille keys, the electronic device 101 can extract data included in the received information, and output a haptic effect for a Braille key mapped to each of the extracted data. In another example embodiment, the electronic device 101 can output, in a haptic form, Braille corresponding to the information received from the external device on the display 160. For example, the electronic device 101 can output the haptic effect to at least a part of the display 160 to represent Braille corresponding to the information received from the external device. In one example embodiment, the haptic effect can include a vibration or tactile response. However, it is not limited to this. In one example embodiment, the display 160 can include a tactile display.

In one example embodiment, the electronic device 101 can output a haptic effect to a part of the electronic device 101 as well as the whole electronic device 101. For example, the electronic device 101 can output the haptic effect such that the whole electronic device 101 is vibrated. In another example, the electronic device 101 can output the haptic effect such that only a part of a construction of the electronic device 101 is vibrated. For example, in case where the electronic device 101 includes a keyboard, the electronic device 101 can allow to vibrate only some Braille keys among a plurality of Braille keys or induce tactile responses of the some Braille keys.

In one example embodiment, in case where a plurality of touches (or contacts) are inputted to the electronic device 101, the electronic device 101 can recognize or disregard the touch input in accordance with a position of the touch input within the electronic device 101. For example, the electronic device 101 can include a plurality of Braille keys and output a haptic effect for at least one Braille key among the plurality of Braille keys. If a user's touch is inputted, for example, to the whole plurality of Braille keys, the electronic device 101 can recognize only an input for at least one Braille key that is outputting the haptic effect, and disregard inputs for the remnant Braille keys.

In one example embodiment, the electronic device 101 can include the portable terminal 430 including a display, the notebook computer 440, etc. as well as the keyboard 420. However, the electronic device 101 including the display is not limited to this.

In one example embodiment, the electronic device 101 can output a haptic effect for a partial region of the display. For example, the electronic device 101 can display a plurality of Braille keys on the display. The electronic device 101 can output a haptic effect for at least one Braille key displayed in a partial region of the display among the plurality of Braille keys.

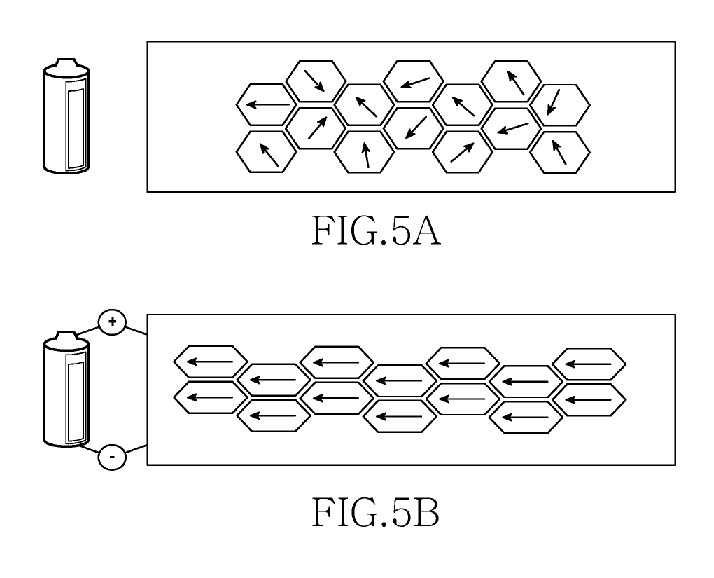

FIGS. 5A and 5B are diagrams illustrating an example principle of outputting a plurality of Braille keys according to one example embodiment.

In one example embodiment, the electronic device 101 can include a plurality of Braille keys capable of outputting a haptic effect.

In one example embodiment, the plurality of Braille keys can be implemented using Electro-Mechanical Polymers (EMPs). For example, the plurality of keys can be each comprised of EMPs. In another example, the plurality of Braille keys can be implemented in a form in which the plurality of Braille keys are each coated with the EMPs.

In a further example, the plurality of Braille keys can be outputted on a tactile display. For example, the plurality of Braille keys can include an EMP layer in which EMP is arranged every position corresponding to a position that is set to output Braille on the display. In one example embodiment, the EMP layer can be laminated on a window of the display 160. In another example embodiment, in case where the display 160 is implemented as a Liquid Crystal Display (LCD), the EMP layer can be implemented to be located between a backlight unit and a housing of the electronic device 101 or a construction of another electronic device 101. However, it is not limited to this. For example, the electronic device 101 can include various types of tactile displays in order to output Braille (or Braille keys).

In one example embodiment, the EMPs can include relaxor ferroelectric electrostictive polymers.

In one example embodiment, the EMPs can have high strain (or tensile) and modulus (i.e., the elastic modulus representing a ratio of stress and strain) compared to other materials. For example, the EMPs can be excellent in aspects of a thickness at actuator implementation, an elastic energy density, a driving voltage at haptic effect output, electric field formation, etc. as well as a strain and the elastic modulus (Mpa), compared to piezoelectric ceramic materials such as lead zirconate titanate (PZT) and dielectric Electro-Active Polymers (dEAPs).

In one example embodiment, the electronic device 101 can output a haptic effect for at least one Braille key among a plurality of Braille keys.

For example, if electricity (or a signal) is applied to EMPs included in each at least one Braille key among a plurality of Braille keys in accordance with a control signal, the EMPs can be deformed physically. For example, in a state in which electricity is not applied to the EMPs, electric charges included within molecules of the EMPs can be distributed in disorder. For example, as illustrated in FIG. 5A, the EMPs can include molecules in which electric dipoles of respectively different directions are formed.

In another example, if electricity is applied to the EMPs included in each of the plurality of Braille keys, an electric field can be generated within the EMPs. By the generated electric field, the electric dipoles formed in the respective molecules constructing the EMPs can be formed in the same direction (or an electric dipole moment having the same direction can be induced). According as the electric dipoles of the respective molecules included within the EMPs are formed in the same direction, a shape (or form) of the respective molecules included within the EMPs can be deformed (or changed) physically. For example, as illustrated in FIG. 5B, the respective molecules of the EMPs of hexagonal forms of FIG. 5A can be deformed in shape to have a form of extending at one axis. In one example embodiment, in case where physical deformation is made, for example, the respective molecules of the EMPs are physically deformed in shape, the electronic device 101 can output a haptic effect for a Braille key including the EMPs.

In one example embodiment, the electronic device 101 can detect a touch (or contact) on at least lone Braille key among a plurality of Braille keys.

For example, in case where a plurality of Braille keys each includes EMPs, if a user touches (contacts with) at least one Braille key among a plurality of keys, the electronic device 101 can detect the touched at least one Braille key. For example, if a physical force is applied to EMPs included in each of at least one Braille key among the plurality of Braille keys, the EMPs can generate electricity. By identifying the Braille key including the EMPs in which electricity is generated, the electronic device 101 can detect the touch on (or contact with) the at least one Braille key among the plurality of Braille keys. In one example embodiment, the touch input for the plurality of Braille keys can include a touch input using one finger (e.g., a drag input using one finger), a multi touch input by at least two or more fingers, an input rubbing the plurality of Braille keys (or a flicking input), a long-touch input of a designated time or more for the plurality of Braille keys, etc. However, it is not limited to this.

In one example embodiment, each Braille key can include six dots (a dot 1 to a dot 6) for representing Braille. In one example embodiment, the six dots can be implemented in a form in which the six dots are engraved within the Braille key. In another example embodiment, the six dots can be implemented in a form in which a sheet on which the six dots are printed is attached to the Braille key. However, it is not limited to this.

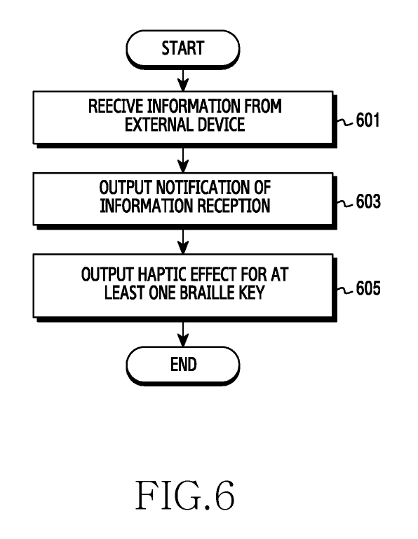

FIG. 6 is a flowchart illustrating an example method for providing information according to one example embodiment.

Referring to FIG. 6, in operation 601, the processor 120 can receive information from an external device. In one example embodiment, the information received from the external device can include information transmitted through a text message (e.g., a Short Message Service (SMS), a Multimedia Messaging Service (MMS), etc.), a mail, a messenger service, etc. However, it is not limited to this.

In one example embodiment, the received information can include a text including at least one of an English language, a Korean language, a numeral, and a special character. However, it is not limited to this.

In one example embodiment, the received information can include user information of the external device. For example, the received information can include a user name of the external device, a telephone number thereof, etc.

In one example embodiment, in operation 603, the processor 120 can allow to output a notification based at least on the received information. For example, the processor 120 can control the speaker 282 to output the notification in a sound form. In another example, the processor 120 can control the motor 298 to output the notification in a form of outputting a vibration of the whole electronic device 101. However, it is not limited to this, and the processor 120 can allow to output the notification in a light form.

In one example embodiment, the processor 120 can output a notification by outputting a haptic effect for at least one Braille key among a plurality of Braille keys. For example, in case where the electronic device 101 includes a keypad and a plurality of Braille keys within the keypad are implemented using EMPs, the processor 120 can allow to output a haptic effect such as a vibration, a tactile response, etc. by applying a signal (or electricity) to the EMPs included in each at least one Braille key among the plurality of Braille keys. In one example embodiment, the Braille key can denote a key including six dots (a dot 1 to a dot 6) such that Braille reading is available.

However, in accordance with an example embodiment, operation 603 can be omitted. For example, a separate notification output operation is omissible in case where the processor 120 sets to straight output a haptic effect for a Braille key corresponding to data included in information received from an external device, after receiving the information from the external device. However, it is not limited to this.

In one example embodiment, in operation 605, the processor 120 can allow to output a haptic effect for at least one Braille key corresponding to text data of the received information that includes sender information.

In one example embodiment, the processor 120 can extract (or classify) a text included in the received information by the unit of data capable of being outputted through a Braille key. In one example embodiment, the unit of data capable of being outputted through the Braille key can be a unit capable of recognizing the order of any one piece of data among a plurality of pieces of data included within a text and the data (or data content) by an operation of a user's one-time touch on the whole plurality of Braille keys constructing a keypad.

In one example embodiment, in case where the received information includes an English language text, the processor 120 can extract each data of an alphabet unit in order from the English language text. For example, in case where the received information includes an English language text ‘kang’, the processor 120 can extract (classify) each data of an alphabet unit in order of ‘k’, ‘a’, ‘n’, and ‘g’ from the ‘kang’. In another example embodiment, in case where the received information includes a Korean language (or Korean) text, the processor 120 can extract data of a phoneme or letter unit. For example, in case where the received information includes a Korean language text ‘ [symbol] ’, the processor 120 can extract data of a phoneme unit in order of phonemes constructing the text, such as ‘ [symbol] ’, ‘ [symbol] ’, ‘ [symbol] ’, ‘ [symbol] ’, ‘ [symbol] ’, ‘ [symbol] ’, ‘ [symbol] ’, ‘ [symbol] ’, and ‘ [symbol] ’. In another example, in case where the received information includes the Korean language text ‘ [symbol] ’, the processor 120 can extract data of a letter unit in order of letters such as ‘ [symbol] ’, ‘ [symbol] ’, and ‘ [symbol] ’.

In one example embodiment, in case where the received information includes a numeral, the processor 120 can extract data by the unit of one numeral in order of constructing the numeral. For example, in case where the received information includes a numeral ‘101’, the processor 120 can extract data by the unit of one numeral in order of ‘1’, ‘0’, and ‘1’.

However, the data the processor 120 is possible to extract from the received information is not limited to this. For example, the processor 120 can extract data on a special character such as a symbol, etc.

In one example embodiment, in case where the received information includes a text that is a combination of at least one of an English language, a Korean language, a numeral, and a special character, the processor 120 can extract the text included in the received information by the unit of data capable of being outputted through Braille keys. For example, in case where the received information includes a combined text ‘kang [symbol] 1’, the processor 120 can extract data capable of being outputted through Braille keys in order of ‘k’, ‘a’, ‘n’, ‘g’, ‘ [symbol] ’, ‘ [symbol] ’, ‘ [symbol] ’, and ‘1’.

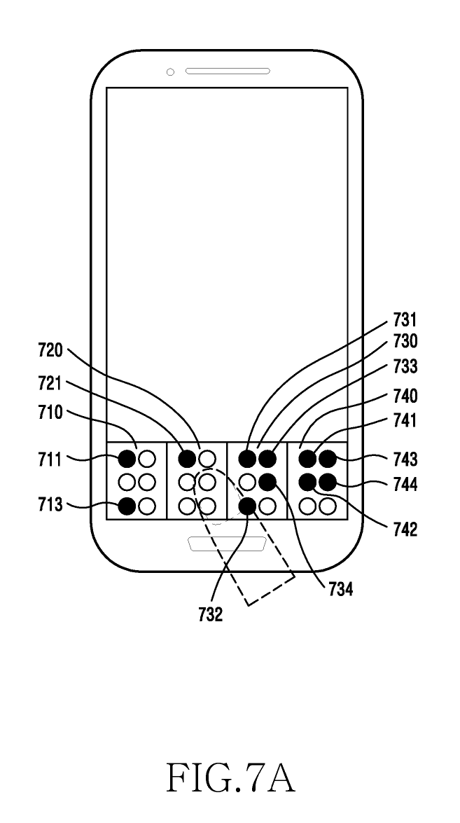

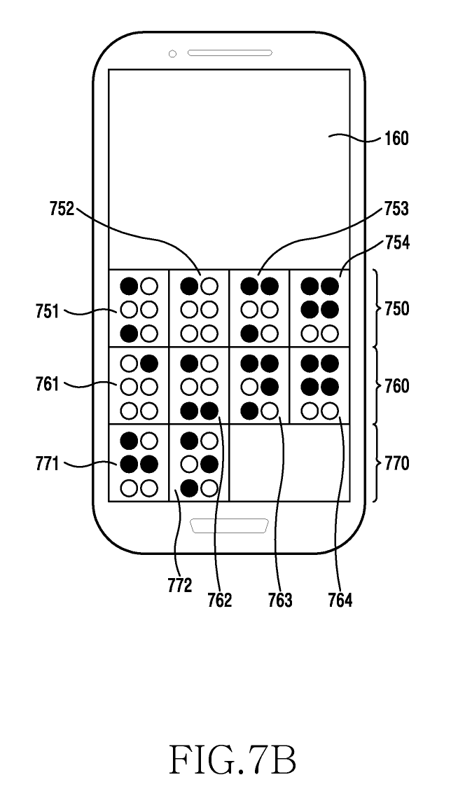

In one example embodiment, the processor 120 can output a haptic effect for a Braille key to represent Braille corresponding to the extracted data. For example, the processor 120 can output the haptic effect (e.g., tactile response) on the display 160 (e.g., a tactile display) such that dots constructing the Braille key are embossed in a hemispheric form (or protrusion form) in order to represent Braille corresponding to the extracted data. A detailed description of this is made in later with reference to FIG. 7.

In one example embodiment, the processor 120 can output a haptic effect for a Braille key mapped to each data that is extracted by a unit capable of being outputted.

In one example embodiment, the processor 120 can allow to output a haptic effect for a Braille key mapped to data for which haptic effect output is determined, in response to a user's touch input for the Braille key mapped to the data for which the haptic effect output is determined. For example, the processor 120 can determine data to output the haptic effect, in order of data constructing a text included in the received information. If the user's touch input for the Braille key mapped to the determined data is received, the processor 120 can allow to output the haptic effect for the Braille key mapped to the determined data. A detailed description will be made with reference to FIG. 7 for the operation of outputting the haptic effect for the Braille key mapped to the data for which the haptic effect output is determined, in response to the user's touch input for the Braille key mapped to the data for which the haptic effect output is determined.

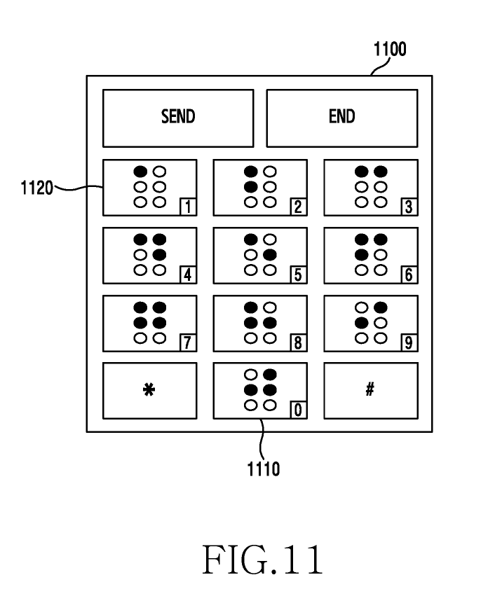

In one example embodiment, the processor 120 can output a haptic effect for a Braille key mapped to data for which haptic effect output is determined and, in response to a user's touch input, output a haptic effect for a Braille key mapped to data corresponding to the next order of the data mapped to the Braille key for which the haptic effect is outputted. Operation of this will be described in detail with reference to FIG. 11.

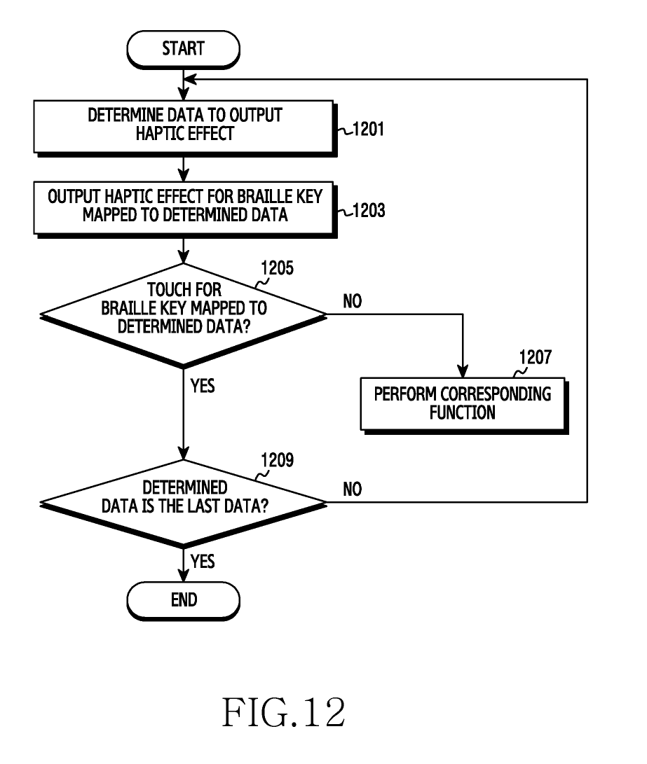

In one example embodiment, in response to a user's touch input, while receiving the touch input, the processor 120 can sequentially output a haptic effect for a Braille key mapped to data constructing a text included in received information. Operation of this will be described in detail with reference to FIG. 12 to FIG. 14.

In one example embodiment, the processor 120 can further perform an operation of determining Braille corresponding to data constructing a text included in received information. For example, in case where a text is comprised of at least one of an English language, a Korean language, a numeral, and a special character, the processor 120 can determine Braille corresponding to data on the at least one of the English language, the Korean language, the numeral, and the special character. For example, the processor 120 can determine Braille corresponding to the data constructing the text, using a Braille chart (or Braille table). In one example embodiment, the processor 120 can allow to output a haptic effect for a Braille key mapped to the determined Braille.

In one example embodiment, operation 605 can be executed under a designated condition.

For example, the processor 120 can output a haptic effect for at least one Braille key in accordance with situation information. For example, the processor 120 can set to output the haptic effect for the at least one Braille key when the situation information around the electronic device, for example, noise is equal to or is greater than a designated level. In another example, the processor 120 can control a display to display received information when the noise is equal to or is less than the designated level. However, the situation information is not limited to the noise, and can include a variety of situations around the electronic device.

In another example, the processor 120 can determine the output or non-output of a haptic effect for at least one Braille key in accordance with notification output setting of received information. For example, in case where the notification output setting is set as a sound, the processor 120 can determine to output the received information by the sound. In another example, in case where the notification output setting is set as a vibration, light, or mute, the processor 120 can determine to output the haptic effect for the at least one Braille key. However, it is not limited to this.

FIGS. 7A and 7B are diagrams illustrating an example method of outputting a haptic effect for at least one Braille key among a plurality of Braille keys according to another example embodiment.

FIG. 7A and FIG. 7B illustrate examples of outputting a haptic effect for a Braille key in order to represent Braille corresponding to data that is extracted from information received from an external device. For example, FIG. 7A illustrates an example of, in case where the extracted data includes ‘kang’, outputting a haptic effect (or a tactile response) for at least one Braille key in order to represent Braille corresponding to the ‘kang’ on the display 160 (e.g., a tactile display).

In one example embodiment, if information is received from an external device, the electronic device 101 can output a virtual (or soft) Braille key in a partial region of the display 160. For example, as illustrated in FIG. 7A, the electronic device 101 can output four Braille keys 710, 720, 730, and 740. In another example embodiment, if the information is received from the external device, the electronic device 101 can output a virtual (or soft) Braille key in the whole region of the display 160 as well.

In one example embodiment, by outputting a haptic effect for dots included in each of a plurality of Braille keys, the electronic device 101 can allow a user to recognize data (or Braille corresponding to the data) included in received information. For example, the electronic device 101 can output a tactile response of dots within a Braille key such that the dots are embossed in a hemispheric form (or protrusion form). For example, the electronic device 101 can allow dots 711 and 713 within a Braille key 710 to be embossed in order to represent Braille corresponding to ‘k’. The electronic device 101 can allow a dot 721 within a Braille key 720 to be embossed in order to represent Braille corresponding to ‘a’. The electronic device 101 can allow dots 731, 732, 733, and 734 within a Braille key 730 to be embossed in order to represent Braille corresponding to ‘n’. The electronic device 101 can allow dots 741, 742, 743, and 744 within a Braille key 740 to be embossed in order to represent Braille corresponding to ‘g’.

In one example embodiment, a user can recognize data included in received information, by touching Braille keys for which a haptic effect for dots is outputted using the finger.

FIG. 7A illustrates that Braille corresponding to data ‘kang’ is outputted from the left to the right, but is not limited to this. For example, the Braille corresponding to the data can be outputted from the right to the left, or be outputted from an upper end of the display to a lower end thereof or from the lower end of the display to the upper end thereof.

In one example embodiment, in case where the number of pieces of data (or Braille corresponding to the data) included in received information is greater than the number of Braille keys, the electronic device 101 can first output Braille corresponding to a part of the data, and then output Braille corresponding to a part of the remnant data after receiving a user input. For example, in case where data is ‘kangjungho’, the electronic device 101 can first output four Braille corresponding to ‘kang’ through the Braille keys 710, 720, 730, and 740, and then output Braille corresponding to data ‘jung’ following the ‘kang’ through the Braille keys 710, 720, 730, and 740 after receiving a touch input for the Braille keys 710, 720, 730, and 740 from a user. If a touch input for the Braille keys 710, 720, 730, and 740 is again received from the user while the Braille corresponding to the ‘jung’ is outputted through the Braille keys 710, 720, 730, and 740, the electronic device 101 can output Braille corresponding to ‘ho’ through the Braille keys 710, 720, 730, and 740. In one example embodiment, after receiving a touch input for Braille keys, the electronic device 101 outputs Braille corresponding to data of the next order of data that is being currently outputted, whereby the user can recognize data included in received information by a continuous touch operation.

In one example embodiment, FIG. 7B illustrates an example in which a keyboard (e.g., a virtual keyboard) is comprised of a plurality of rows each including a plurality of Braille keys. For example, the keyboard can include three rows 750, 760, and 770, and each row can include a plurality of Braille keys.

In one example embodiment, as illustrated in FIG. 7B, in case where a keyboard is comprised of a plurality of rows, the electronic device 101 can output Braille corresponding to a lot of pieces of data at once. For example, in FIG. 7B, the electronic device 101 can output Braille corresponding to ‘kang’ at the first row 750, Braille corresponding to ‘jung’ at the second row 760, and Braille corresponding to ‘ho’ at the third row 760.

In one example embodiment, in case where a keyboard includes a plurality of rows, a user can recognize data by touching a region of each row. For example, the user can recognize Braille outputted through the first row 750 by touching (or dragging) Braille keys 751, 752, 753, 754 included in the first row 750 using the finger. The user can recognize Braille outputted through the second row 760 and the third row 770 by touching Braille keys 761, 762, 763, and 764 included in the second row 760 and Braille keys 771 and 772 included in the third row 770.

FIG. 7B illustrates that a virtual keyboard includes three rows and each row includes four Braille keys, but is not limited to this.

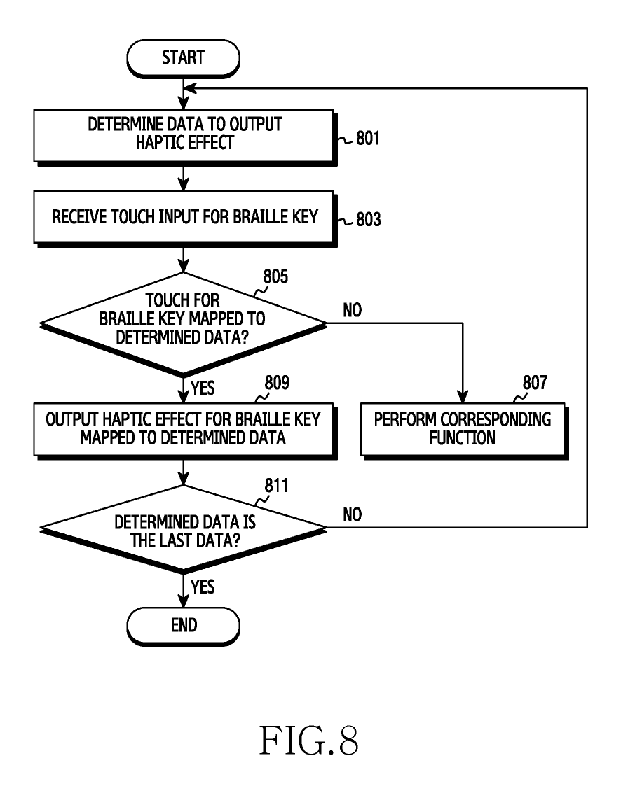

FIG. 8 is a flowchart illustrating an example method of outputting a haptic effect for at least one Braille key among a plurality of Braille keys according to one example embodiment.

Referring to FIG. 8, in one example embodiment, in operation 801, the processor 120 can determine data to output a haptic effect. For example, the processor 120 can determine the data to output the haptic effect (hereinafter, referred to as ‘determined data’) in order of data constructing a text included in received information.

In one example embodiment, if the processor 120 outputs a haptic effect for a Braille key mapped to data, the processor 120 can determine data corresponding to the next order (or corresponding to the next arrangement order) of the data mapped to the Braille key for which the haptic effect is outputted, as data to output a haptic effect. For example, in case where received information includes an English language text ‘kang’, the processor 120 can determine data ‘n’ arranged following data ‘a’ as the data to output the haptic effect, after outputting a haptic effect for a Braille key mapped to the data ‘a’.

In operation 803, the processor 120 can receive a touch input for at least one of a plurality of Braille keys from a user.

In one example embodiment, the touch input for the plurality of Braille keys can include a multi touch input by at least two or more fingers, a rubbing touch input (or a flicking input), etc. For example, the touch input for the plurality of Braille keys can be a touch input rubbing the plurality of Braille keys of the electronic device 101 (e.g., the keypad) from the left to the right by the user's hand. However, it is not limited to this. For example, the touch input for the plurality of Braille keys can include all of an input by a touch on the plurality of Braille keys such as a multi touch input for the plurality of Braille keys, a palm touch input using the palm, etc.

In one example embodiment, in operation 805, the processor 120 can determine if a touch input for at least one Braille key (hereinafter, referred to as a ‘determined Braille key’) mapped to the determined data among a plurality of Braille keys is received from a user.

In one example embodiment, if determining in operation 803 that the touch input for the determined Braille key among the plurality of Braille keys is not received from the user, in operation 805, the processor 120 can allow to perform a corresponding function. For example, the processor 120 can allow to disregard a touch input for another Braille key, not the determined Braille key. In another example, if receiving an input for another function key not a Braille key, the processor 120 can allow to execute a function mapped to the another function key.

In one example embodiment, in operation 809, the processor 120 can allow to output a haptic effect for the determined Braille key. For example, the processor 120 can allow to vibrate the determined Braille key or induce a tactile response of the determined Braille key, by means of EMPs included in the determined Braille key. However, it is not limited to this. For example, the processor 120 can control the speaker 282 to output Braille mapped to the determined Braille key in a voice form as well.

In one example embodiment, the processor 120 can allow to output a haptic effect for the determined Braille key for a designated time. For example, the processor 120 can allow to output the haptic effect for the determined Braille key for a preset time after a user touches the determined Braille key. In another example, the processor 120 can allow to output the haptic effect for the determined Braille key only while the user touches the determined Braille key. In a further example, the processor 120 can allow to detect a touch on the determined Braille key and output the haptic effect for the determined Braille key, while receiving a touch input for the determined Braille key by the user's finger. However, it is not limited to this.

In one example embodiment, in operation 811, the processor 120 can determine if the determined data is the last data constructing a text. For example, the processor 120 can determine if it has outputted all of a text included in received information, or has outputted a haptic effect for a Braille key mapped to each of the whole data constructing the text included in the received information. For example, in case where the text included in the received information is ‘kang’ and the determined data is ‘g’, the processor 120 can determine the data ‘g’ as the last data constructing the text.

In one example embodiment, if determining in operation 811 that the determined data is not the last data constructing the text, the processor 120 can return to operation 801 and determine data following data that is currently determined (or data corresponding to the next order), as data to output a haptic effect.

In one example embodiment, if determining in operation 811 that the determined data is the last data constructing the text, the processor 120 can end an information provision operation.

In one example embodiment, in operation 805 if it is determined that there is not a mapping, the device performs the corresponding function in operation 807.

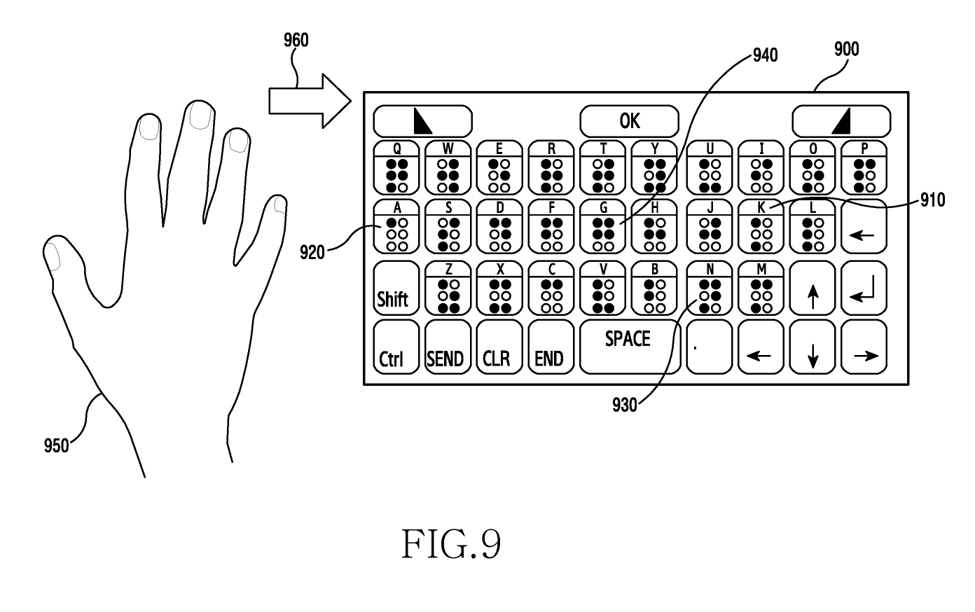

FIG. 9 is a diagram illustrating an example method of outputting a haptic effect for at least one Braille key among a plurality of Braille keys according to an example embodiment.

FIG. 9 illustrates a case in which a plurality of Braille keys are mapped to English language (or alphabet) data, but it is not limited to this.

In one example embodiment, an electronic device 900 can output a notification of received information, and extract (or classify) a text included in the received information by the unit of data capable of being outputted through Braille keys. For example, in case where the received information includes an English language text ‘kang’, the electronic device 900 can extract ‘k’, ‘a’, ‘n’, and ‘g’ by the unit of data capable of being outputted through Braille keys, for example, by the unit of alphabet, from the English language text ‘kang’.

In one example embodiment, the electronic device 900 can determine data to output a haptic effect. For example, in case where received information includes an English language text ‘kang’, the electronic device 900 can determine data ‘k’ arranged at the head of the English language text ‘kang’, as the data to output the haptic effect (hereinafter, referred to as ‘determined data’), in order of data constructing the English language text ‘kang’. In one example embodiment, the electronic device 900 can determine a Braille key mapped to the determined data, as a Braille key to output a haptic effect (hereinafter, referred to as a ‘determined Braille key’).

In one example embodiment, the electronic device 900 can receive a touch input for a plurality of Braille keys of the electronic device 900 (e.g., keypad) from a user. For example, as illustrated in FIG. 9, the electronic device 900 can receive a touch input by the user's hand 950 in an arrow direction 960 (e.g., a direction from the left to the right). The touch input from the user is not limited to the example of FIG. 9. For example, the touch input for the plurality of Braille keys can be a multi touch input by at least two or more fingers. In another example, the touch input for the plurality of Braille keys can include a touch input having a direction such as a direction from the right to the left, a direction from up to down, a direction from down to up, etc., different from the arrow direction.

In one example embodiment, the electronic device 900 can determine if a touch input for the determined Braille key is received from a user. For example, in case where received information includes an English language text ‘kang’ and determined data is ‘k’, the electronic device 900 can determine if an input by the user's hand for a Braille key 910 mapped to the data ‘k’ is received. If the electronic device 900 determines that the touch input by the user's hand for the Braille key 910 is received, the electronic device 900 can output a haptic effect for the Braille key 910. For example, the electronic device 900 can allow to output a vibration or tactile response of the Braille key 910. In one example embodiment, the electronic device 900 can output a haptic effect for the Braille key 910 for a designated time. For example, the electronic device 900 can output the haptic effect for the Braille key 910 for a preset time after the user touches the Braille key 910. In another example, the electronic device 900 can output the haptic effect for the Braille key 910 only while the user touches the Braille key 910. In a further example, the electronic device 900 can allow to detect a touch on the Braille key 910 and output the haptic effect for the Braille key 910, while receiving a touch input by the user's finger. However, it is not limited to this.

In one example embodiment, if the electronic device 900 outputs a haptic effect for the Braille key 910, in case where received information includes an English language text ‘kang’ and determined data is ‘k’, the electronic device 900 can determine data ‘a’ following the data ‘k’ (corresponding to the next order) as data to output a haptic effect. In one example embodiment, the electronic device 900 can determine a Braille key 920 mapped to the data ‘a’, as a Braille key to output a haptic effect. In one example embodiment, if the electronic device 900 determines that a touch input by the user's hand for the Braille key 920 is received from a user, the electronic device 900 can output a haptic effect for the Braille key 920. In one example embodiment, the electronic device 900 can determine data ‘n’ following data ‘a’ (or corresponding to the next order), as data to output a haptic effect. In one example embodiment, the electronic device 900 can determine a Braille key 930 mapped to the data ‘n’, as a Braille key to output the haptic effect. In one example embodiment, if the electronic device 900 determines that a touch input by the user's hand for the Braille key 930 is received from the user, the electronic device 900 can output a haptic effect for the Braille key 930. In one example embodiment, the electronic device 900 can determine data ‘g’ following the data ‘n’ (or corresponding to the next order), as data to output a haptic effect. In one example embodiment, the electronic device 900 can determine a Braille key 940 mapped to the data ‘g’, as a Braille key to output a haptic effect. In one example embodiment, if the electronic device 900 determines that a touch input by the user's hand for the Braille key 940 is received from the user, the electronic device 900 can output a haptic effect for the Braille key 940.

In one example embodiment, in case where received information includes an English language text ‘kang’ and the electronic device 900 completes the outputting of a haptic effect for each of Braille keys mapped to ‘j’, ‘a’, ‘n’, and ‘g’, the electronic device 900 can end an information provision operation or a haptic effect output operation.

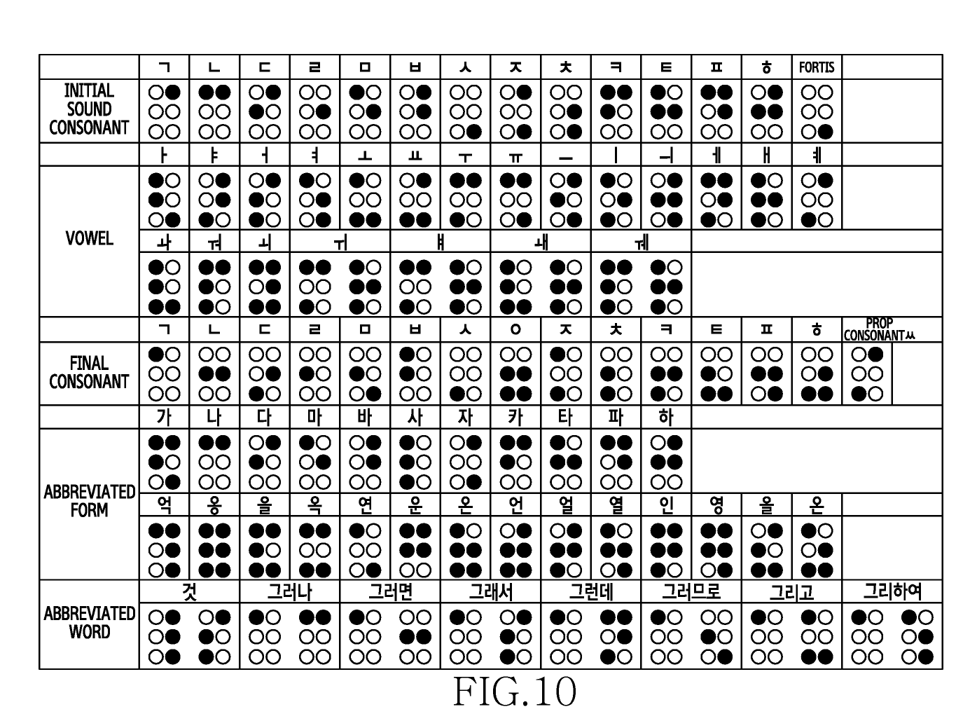

FIG. 10 is a diagram illustrating an example method of outputting a haptic effect for at least one Braille key among a plurality of Braille keys according to another example embodiment.

FIG. 10 illustrates a Korean-language Braille chart for describing a method of outputting a haptic effect for a Braille key mapped to data constructing a Korean language (or Korean) text in case where received information includes the text.

In one example embodiment, in case where received information includes a Korean language text, the electronic device 101 can output data of a phoneme unit, a letter unit, and a word unit.

For example, in case where received information is ‘ [symbol] ’, the electronic device 101 can output a haptic effect for a Braille key mapped to each of ‘ [symbol] ’, ‘ [symbol] ’, and ‘ [symbol] ’ by the unit of phoneme such as ‘ [symbol] ’, ‘ [symbol] ’, and ‘ [symbol] ’. For example, while receiving a first touch input from a user, the electronic device 101 can output the haptic effect for the Braille key mapped to the ‘ [symbol] ’ being an initial sound consonant in order of phonemes constructing a text. After outputting the haptic effect for the Braille key mapped to the ‘ [symbol] ’, while receiving a second touch input from the user, the electronic device 101 can output the haptic effect for the Braille key mapped to the ‘ [symbol] ’ being a vowel. After outputting the haptic effect for the Braille key mapped to the ‘ [symbol] ’, while receiving a third touch input from the user, the electronic device 101 can output the haptic effect for the Braille key mapped to the ‘ [symbol] ’ being a final consonant.

In another example, in case where received information includes a Korean language text ‘ [symbol] ’, the electronic device 101 can concurrently output a haptic effect for a Braille key mapped to a letter unit, for example, each of ‘ [symbol] ’ being an initial sound consonant, ‘ [symbol] ’ being a vowel, and ‘ [symbol] ’ being a final consonant. For example, while receiving a touch input from a user, the electronic device 101 can concurrently output the haptic effect for the Braille keys mapped to the respective ‘ [symbol] ’, ‘ [symbol] ’, and ‘ [symbol] ’.

In another example, in case where received information includes an abbreviated syllable (e.g., ‘ [symbol] ’) or a word (e.g., ‘ [symbol] ’) as a Korean language text, the electronic device 101 can output a haptic effect for a Braille key mapped to the abbreviated syllable ‘ [symbol] ’ or the word ‘ [symbol] ’.

FIG. 11 is a diagram illustrating an example method of outputting a haptic effect for at least one Braille key among a plurality of Braille keys according to a further example embodiment.

FIG. 11 illustrates an electronic device (e.g., a keypad) including Braille keys mapped to data (or Braille) corresponding to numerals.

In one example embodiment, in case where received information includes a numeral ‘101’, the electronic device 1100 can extract ‘1’, ‘0’, and ‘1’ by the unit of numeral from the received information ‘101’. The electronic device 1100 can output a haptic effect for a Braille key 1120 mapped to ‘1’, a Braille key 1110 mapped to ‘0’, and a Braille key 1120 mapped to ‘1’, in order of numerals constructing the received information ‘101’. However, it is not limited to this.

FIG. 12 is a flowchart illustrating an example method of outputting a haptic effect for at least one Braille key among a plurality of Braille keys according to another example embodiment.

Referring to FIG. 12, in one example embodiment, in operation 1201, the processor 120 can determine data to output a haptic effect. For example, the processor 120 can determine the data to output the haptic effect (hereinafter, referred to as ‘determined data’) in order of data constructing a text included in received information.

In one example embodiment, in case where a touch input for a Braille key for which a haptic effect is being outputted is received from a user, the processor 120 can determine data corresponding to the next order (or corresponding to the next arrangement order) of data mapped to the Braille key for which the touch input is received, as data to output a haptic effect. For example, in case where received information includes an English language text ‘kang’, after the processor 120 outputs a haptic effect for a Braille key mapped to ‘a’ and receives a touch input for the Braille key mapped to the ‘a’ from the user, the processor 120 can determine ‘n’ arranged following the ‘a’, as data to output a haptic effect.

In one example embodiment, in operation 1203, the processor 120 can allow to output a haptic effect for a Braille key mapped to the determined data. For example, the processor 120 can allow to vibrate a determined Braille key or induce a tactile response of the determined Braille key, using EMPs included in the determined Braille key. However, it is not limited to this. For example, the processor 120 can control the speaker 282 to output Braille mapped to the determined Braille key in a voice form as well.

In operation 1205, the processor 120 can determine if a touch input for the Braille key mapped to the determined data is received from a user. In one example embodiment, the touch input for the Braille key can include a touch input (e.g., a drag input), a multi touch input by at least two or more fingers, a rubbing touch input (or flicking input), etc. For example, the touch input for the Braille key can be a touch input rubbing a plurality of Braille keys from the left to the right using the user's finger for the electronic device 101 (e.g., keypad). However, it is not limited to this.

In one example embodiment, if determining in operation 1205 that the touch input for the determined Braille key is not received, in operation 1207, the processor 120 can allow to perform a corresponding function. For example, the processor 120 can allow to disregard a touch input for another Braille key, not the determined Braille key. In another example, if receiving a touch input for another function key, not a Braille key, the processor 120 can allow to execute a function mapped to the another function key.

In one example embodiment, in case where the processor 120 determines in operation 1205 that it receives the touch input for the determined Braille key, in operation 1209, the processor 120 can determine if the determined data is the last data constructing a text. For example, the processor 120 can determine if it has outputted all of a text included in received information, or has outputted a haptic effect for a Braille key mapped to each of the whole data constructing the text included in the received information. For example, in case where the text included in the received information is ‘kang’ and the determined data is ‘g’, the processor 120 can determine the data ‘g’ as the last data constructing the text.

In one example embodiment, if determining in operation 1209 that the determined data is not the last data constructing the text, the processor 120 can return to operation 1201 and determine data following data currently determined (or data corresponding to the next order), as data to output a haptic effect.

In one example embodiment, if determining in operation 1209 that the determined data is the last data constructing the text, the processor 120 can end an information provision operation.

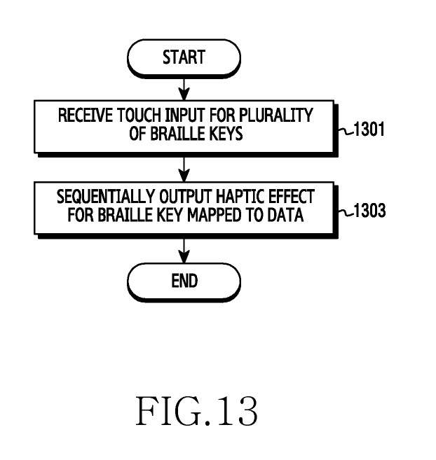

FIG. 13 is a flowchart illustrating an example method of outputting a haptic effect for at least one Braille key among a plurality of Braille keys according to a further example embodiment.

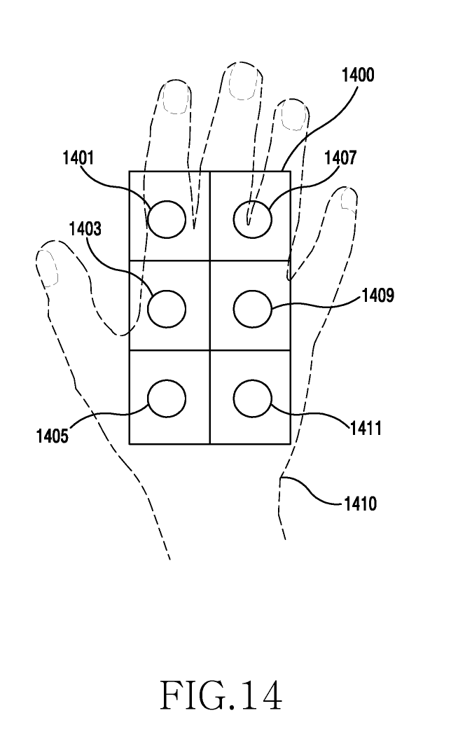

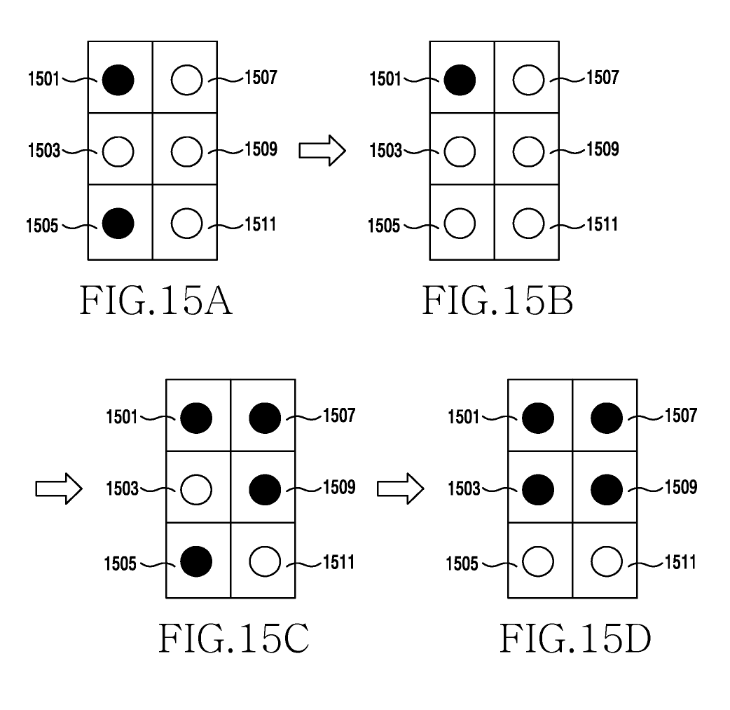

FIGS. 14 and 15A, 15B, 15C and 15D are example diagrams for describing a method of outputting a haptic effect for at least one Braille key among a plurality of Braille keys according to a yet another example embodiment.

Referring to FIG. 13 to FIG. 15A-15D, in operation 1301, the processor 120 can receive a touch input for a plurality of Braille keys from a user.

In one example embodiment, the touch input for the plurality of Braille keys can include a touch input for the whole plurality of Braille keys included in the electronic device 101 (e.g., keypad).

In one example embodiment, as illustrated in FIG. 14, the electronic device 101 can be a keypad consisting of a plurality of Braille keys 1401 to 1411 each including a dot 1 to a dot 6. In one example embodiment, in case where the electronic device 101 consists of the plurality of Braille keys 1401 to 1411 each including the dot 1 to the dot 6 as illustrated in FIG. 14, the electronic device 101 can output a haptic effect for a Braille key to represent Braille corresponding to each data included in a text.

In one example embodiment, the electronic device 101 of a keypad form can be implemented to have a size or area that at contact (or at touch) is covered with the user's hand.

In one example embodiment, in operation 1303, the processor 120 can allow to sequentially output a haptic effect for a Braille key that includes dots constructing Braille corresponding to data constructing a text included in received information.

For example, while the touch input (or long-touch input or holding input) for the plurality of Braille keys is received in operation 1301, the processor 120 can allow to output a haptic effect for a Braille key including dots constructing Braille corresponding to data, in order of the data constructing the text included in the received information. In one example embodiment, the processor 120 can allow to output the haptic effect for the Braille key including the dots constructing the Braille corresponding to the data, at a designated time interval.

In one example embodiment, in case where received information is ‘kang’, as illustrated in FIG. 15A to FIG. 15D, the processor 120 can sequentially output a haptic effect for Braille keys 1501 and 1505 including dots constructing Braille corresponding to ‘k’, a haptic effect for a Braille key 1501 including a dot constructing Braille corresponding to ‘a’, a haptic effect for Braille keys 1501, 1505, 1507, and 1509 including dots constructing Braille corresponding to ‘n’, and a haptic effect for Braille keys 1501, 1503, 1507, and 1509 including dots constructing Braille corresponding to ‘k’.

Though not illustrated in FIG. 13, in case where data constructing the text ‘kang’ included in the received information are all outputted, an operation of providing information or an operation of outputting a haptic effect for a Braille key can be ended.

A method for providing information of an electronic device 101 according to various example embodiments can include receiving information through a communication interface, and outputting a haptic effect for at least one Braille key among a plurality of Braille keys, based on the received information.

In one example embodiment, the plurality of Braille keys can be implemented using EMPs.

In one example embodiment, the haptic effect for the at least one Braille key can include a vibration or tactile response of the at least one Braille key.

In one example embodiment, outputting the haptic effect for the at least one Braille key among the plurality of Braille keys can include determining data to output the haptic effect based at least on the received information and, if receiving a touch input for a Braille key mapped to the determined data, outputting a haptic effect for the Braille key mapped to the determined data.

In one example embodiment, the method can further include, while receiving the touch input for the Braille key mapped to the determined data, outputting the haptic effect, and determining data corresponding to the next order of the determined data, as the data to output the haptic effect.

In one example embodiment, outputting the haptic effect for the at least one Braille key among the plurality of Braille keys can include determining data to output the haptic effect based at least on the received information, and outputting a haptic effect for a Braille key mapped to the determined data.

In one example embodiment, the method can further include, if receiving a touch input for the mapped Braille key, determining data corresponding to the next order of the determined data, as the data to output the haptic effect.

In one example embodiment, outputting the haptic effect for the at least one Braille key among the plurality of Braille keys can include, if receiving a touch input from a user, sequentially outputting each of data included in the received information using the haptic effect.

In one example embodiment, the method can further include, if receiving the information through the communication interface, outputting a notification notifying the information reception.

In one example embodiment, the electronic device 101 can include a keypad including a plurality of Braille keys, or a virtual display displaying the plurality of Braille keys.

As mentioned above, a method for providing information and the electronic device 101 supporting the same according to various example embodiments can make it possible for a user to recognize a notification of information reception and more accurately identify information received from the external, by outputting a haptic effect for at least one Braille key based on the information received from the external.

Meanwhile, the aforementioned example embodiments are possible to be implemented as a program executable in a computer, and can be implemented in a generic digital computer that operates the program using a computer-readable recording medium. Also, a structure of data used in the aforementioned example embodiment can be recorded in the computer-readable recording medium through various means. The computer-readable recording medium includes a storage medium such as a magnetic storage medium (for example, a Read Only Memory (ROM), a floppy disc, a hard disc, etc.), an optical reading medium (for example, a Compact Disc-ROM (CD-ROM), a Digital Versatile Disc (DVD), etc.).

In one example embodiment, the recording medium can record a program for executing the operations of receiving information through a communication interface, and outputting a haptic effect for at least one Braille key among a plurality of Braille keys based at least on the received information, in a method for providing information in the electronic device 101.

Hitherto, various example embodiments have been described aiming at preferred example embodiments thereof. It will be understood by those skilled in the art that changes in form can be made without departing from the spirit and scope of the present disclosure. Therefore, disclosed example embodiments should be taken into consideration in a descriptive aspect, not in a restrictive aspect. The scope of the present disclosure is presented in the appended claims, not in the above description, and it should be interpreted that all differences within the scope equivalent to them are included in the present disclosure.

What is claimed is:

1. An electronic device comprising:
communication circuitry configured to receive information from an external device; and
a processor,
wherein the processor is configured to output a haptic effect for at least one Braille key among a plurality of Braille keys, based on the information received through the communication circuitry.

2. The electronic device of claim 1, wherein the plurality of Braille keys are implemented using Electro-Mechanical Polymers (EMPs).

3. The electronic device of claim 1, wherein the haptic effect for the at least one Braille key comprises one or more of a vibration or tactile response of the at least one Braille key.

4. The electronic device of claim 1, wherein the processor is configured to output a tactile response of the at least one Braille key from a display, to represent Braille corresponding to data included in the received information.

5. The electronic device of claim 1, wherein the processor is configured to determine data to output the haptic effect based at least on the received information, and
to output a haptic effect for the Braille key mapped to the determined data if a touch input for a Braille key mapped to the determined data is received.

6. The electronic device of claim 5, wherein, the processor is configured to output the haptic effect, and to determine data corresponding to the next order of the determined data, as the data to output the haptic effect while receiving the touch input for the Braille key mapped to the determined data.

7. The electronic device of claim 1, wherein the processor is configured to determine data to output the haptic effect based at least on the received information, and
to output a haptic effect for a Braille key mapped to the determined data.

8. The electronic device of claim 7, wherein, the processor is configured to determine data corresponding to the next order of the determined data, as the data to output the haptic effect if a touch input for the mapped Braille key is received.

9. The electronic device of claim 1, wherein, the processor is configured to sequentially output each of data included in the received information using the haptic effect if a touch input is received.

10. The electronic device of claim 1, wherein, the processor is configured to output a notification of the information reception if the information is received through the communication circuitry.

11. A method for providing information of an electronic device, the method comprising:
receiving information through a communication interface; and
outputting a haptic effect for at least one Braille key among a plurality of Braille keys, based on the received information.

12. The method of claim 11, wherein the plurality of Braille keys are implemented using EMPs.

13. The method of claim 11, wherein the haptic effect for the at least one Braille key comprises a vibration or tactile response of the at least one Braille key.

14. The method of claim 11, further comprising outputting a tactile response of the at least one Braille key from a display, to represent Braille corresponding to data comprised in the received information.

15. The method of claim 11, wherein outputting the haptic effect for the at least one Braille key among the plurality of Braille keys comprises:
determining data to output the haptic effect based at least on the received information; and
outputting a haptic effect for the Braille key mapped to the determined data if a touch input for a Braille key mapped to the determined data is received.

16. The method of claim 15, further comprising:
outputting the haptic effect while receiving the touch input for the Braille key mapped to the determined data; and
determining data corresponding to the next order of the determined data, as the data to output the haptic effect.

17. The method of claim 11, wherein outputting the haptic effect for the at least one Braille key among the plurality of Braille keys comprises:
determining data to output the haptic effect based at least on the received information, and
outputting a haptic effect for a Braille key mapped to the determined data.

18. The method of claim 17, further comprising, determining data corresponding to the next order of the determined data, as the data to output the haptic effect is a touch input for the mapped Braille key is received.

19. The method of claim 11, outputting the haptic effect for the at least one Braille key among the plurality of Braille keys comprising, if receiving a touch input from a user, and sequentially outputting each of data included in the received information using the haptic effect.

20. The method of claim 11, further comprising, outputting a notification of the information reception if the information is received through the communication interface.
